(19) United States
(12) Patent Application Publication
(10) Pub. No.: US 2022/0076377 A1
(43) Pub. Date: Mar. 10, 2022

(54) System and Method of Stitching Partial Facial Images for Custom Printed Facemasks

(71) Applicant: Faceful Prints LLC, Tujunga, CA (US)

(72) Inventors: Arno Stephanian, Tujunga, CA (US); Artavazd Barseghyan, Yerevan (AM)

(21) Appl. No.: 17/447,051

(22) Filed: Sep. 7, 2021

Related U.S. Application Data
(60) Provisional application No. 63/074,664, filed on Sep. 4, 2020.

(51) Int. Cl. G06T 3/40; G06T 5/50; G06K 9/00

(52) U.S. Cl. CPC G06T 3/4038; G06K 9/00228; G06K 9/00281; G06T 5/50

(57) ABSTRACT

A system and method of taking in three images of a face, left, right and center. The images are then detected with some feature points that have landmark points associated with them. The individual images are cutout based on preset criteria using the landmark points. The right and left cutouts are placed side by side. The center cutout is overlaid on top of the combined left and right image at some offset and refence points. The resulting image is then saved and outputted for a user to further process and/or order the image to be printed on to a face mask. Facemask contains partial image of a wearer's face making if lifelike.

### PRIORITY CLAIMS AND CROSS-REFERENCE TO RELATED APPLICATIONS

This application is related to and claims domestic priority benefits under 35 USC § 119(e) from U.S. Provisional Patent Application Ser. No. 63/074,664 filed on Sep. 4, 2020, the entire contents, of the aforementioned application, are expressly incorporated hereinto by reference.

### BACKGROUND

The invention relates to combining digital images of a person's face and creating facemasks depicting the combined image.

### SUMMARY

In accordance with an aspect of the disclosures, there is provided a method to stitch multiple images for creating a facemask by: capturing a right-side image of a face, capturing a left-side image of the face, capturing a center-side image of the face, detecting facial landmarks from each of the captured images, processing each of the captured images, stitching the processed images together, and outputting the resulting stitched image. Furthermore, the method detects of facial landmarks using a Histogram of Oriented Gradients (HOG) to find the landmark points. The method also processes the right-side image by cropping a section of the face, based on some of the facial landmarks; processes the left-side image by cropping a section of the face, based on some of the facial landmarks; and processes the center-side image by setting a polygon section of the face, based on some of the facial landmarks, and using the polygon section as a mask to extract pixels from the center-side image that results into the processed center-side image.

The method further sets the processed left-side image next to the processed right-side image such that a common landmark reference point is used to align the y-coordinate and the width of the processed right-side image is used to align the x-coordinate; and overlays the processed center-side image on top of the stitched processed left-side image that was placed next to the processed right-side image such that the overlaying of the processed center-side image is anchored at an x-coordinate based on the addition of the widths of the processed left-side image and the processed right-side image subtracted by the original width and further anchored at a y-coordinate based on a common landmark reference point of the processed right-side image and the center-side image.

The method finally outputs the resulting stitched image for the user to generate a facemask based on a template of a facemask.

In accordance with an aspect of the disclosures, there is provided a system to stitch multiple images for creating a facemask using, one or more processors operatively coupled to one or more memory devices; one or more set of instructions, wherein the one or more set of instructions are stored in the one or more memory devices and configured to be executed by the one or more processors, wherein the one or more set of instructions include executable instructions to: capture a right-side image of a face, capture a left-side image of the face, capture a center-side image of the face, detect facial landmarks from each of the captured images, process each of the captured images, stitch the processed images together, and output the resulting stitched image.

The system further has executable instructions that detects facial landmarks using a Histogram of Oriented Gradients (HOG) to find the landmark points.

The system further has executable instructions that, processes the right-side image by cropping a section of the face, based on some of the facial landmarks, processes the left-side image by cropping a section of the face, based on some of the facial landmarks, and processes the center-side image by setting a polygon section of the face, based on some of the facial landmarks, and using the polygon section as a mask to extract pixels from the center-side image that results into the processed center-side image.

Moreover, the system further has executable instructions that, sets the processed left-side image next to the processed right-side image such that a common landmark reference point is used to align the y-coordinate and the width of the processed right-side image is used to align the x-coordinate, and overlays the processed center-side image on top of the stitched processed left-side image that was placed next to the processed right-side image such that the overlaying of the processed center-side image is anchored at an x-coordinate based on the addition of the widths of the processed left-side image and the processed right-side image subtracted by the original width and further anchored at a y-coordinate based on a common landmark reference point of the processed right-side image and the center-side image.

Finally, the system further has executable instructions that, outputs a resulting stitched image for the user to generate a facemask based on a template of a facemask.

In accordance with an aspect of the disclosures, there is provided a computer program product to stitch multiple images for creating a facemask using program instructions executable for: capturing a right-side image of a face, capturing a left-side image of the face, capturing a center-side image of the face, detecting facial landmarks from each of the captured images, processing each of the captured images, stitching the processed images together, and outputting the resulting stitched image.

Moreover, the computer program product has program instructions executable for detecting facial landmarks using a Histogram of Oriented Gradients (HOG) to find the landmark points.

Furthermore, the computer program product has program instructions executable for processing the right-side image by cropping a section of the face, based on some of the facial landmarks, processing the left-side image by cropping a section of the face, based on some of the facial landmarks, and processing the center-side image by setting a polygon section of the face, based on some of the facial landmarks, and using the polygon section as a mask to extract pixels from the center-side image that results into the processed center-side image.

In addition, the computer program product has program instructions executable for, setting the processed left-side image next to the processed right-side image such that a common landmark reference point is used to align the y-coordinate and the width of the processed right-side image is used to align the x-coordinate, and overlaying the processed center-side image on top of the stitched processed left-side image that was placed next to the processed right-side image such that the overlaying of the processed center-side image is anchored at an x-coordinate based on the addition of the widths of the processed left-side image and the processed right-side image subtracted by the original width and further anchored at a y-coordinate based on a common landmark reference point of the processed right-side image and the center-side image.

Finally, the computer program product has program instructions executable for outputting the resulting stitched image for the user to generate a facemask based on a template of a facemask.

### DESCRIPTION OF THE DRAWINGS

Embodiments in accordance with the present technology are shown in the drawings and will be described below with reference to the figures, whereby elements having the same effect have been provided with the same reference numerals. The following is shown:

FIG. 1 shows a schematic view of the present system from a high-level perspective exemplifying an embodiment of the system that enables taking partial images of a person's face and stitching them together;

FIG. 2 shows an exemplary image of a user's face with facial features placed with landmark points;

FIG. 3 shows a stitched image that combines a cutout of the left image, a cutout of the right image and cutout of the center image;

FIG. 4 is a block diagram of the electronics and computational structure of an embodiment of the present system;

FIG. 5 illustrates an exemplary flowchart of an embodiment of the present method, carried out on the system.

### DESCRIPTION

The present technology is composed of a system and method enabling a user to take partial images of a person's face and stitch them together for incorporating the stitched lifelike image unto a facemask. Furthermore, Appendix A incorporated here by reference, some of the technology as discussed herein.

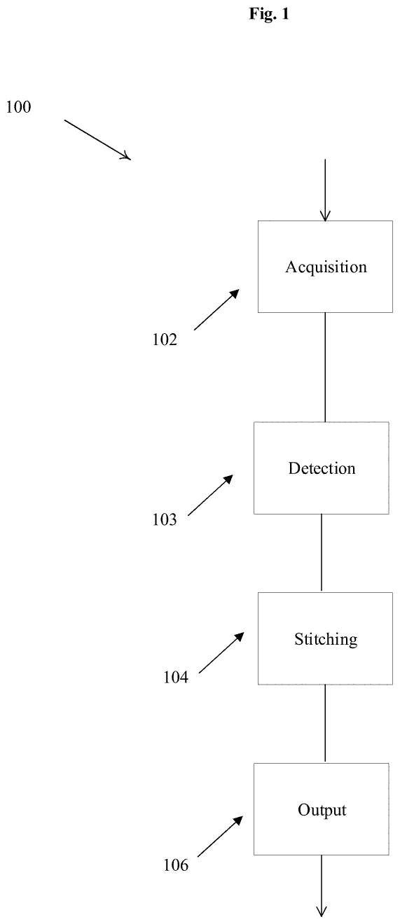

In FIG. 1, the present technology is described in a schematic view of the system from a high-level perspective exemplifying an embodiment of taking partial images of a person's face and stitching them together in environment 100. The user has a platform of the system 100 installed or accessible on their machine. Throughout this disclosure, the machine can be a computer, a tablet pc, a smart-phone, a smart-watch, an integrated AR/VR (Augmented Reality/Virtual Reality) headwear with the necessary computing and computer vision components installed, a smart-television, an interactive screen, a smart projector or a projected platform, an IoT (Internet of things) device or the like that are capable of capturing images and/or transferring already taken images and/or processing images.

The user can utilize the platform to use three images of their face at the acquisition stage 102. In some embodiments, the acquisition 102 can use a camera built into the machine to capture a set of images. In some embodiments the user is prompted by the system 100 to take images of the right side, the middle side and left side of their face. In some embodiments a template is generated for the user to line up the anatomical parts of their face unto the template that is displayed on a display screen in order to capture what is necessary for later reprocessing. In some embodiments, the user can use an uploaded image or a saved image to apply the template unto and derive the set of three images. In other embodiments, the user can take the right, center, and left images without a template and the system 100 will notify them if the captured data is sufficient for processing. This is done by comparing to some thresholds and determining whether the images taken are within some tolerance range. The left and right images can be within a maximum deviation of 45 degrees.

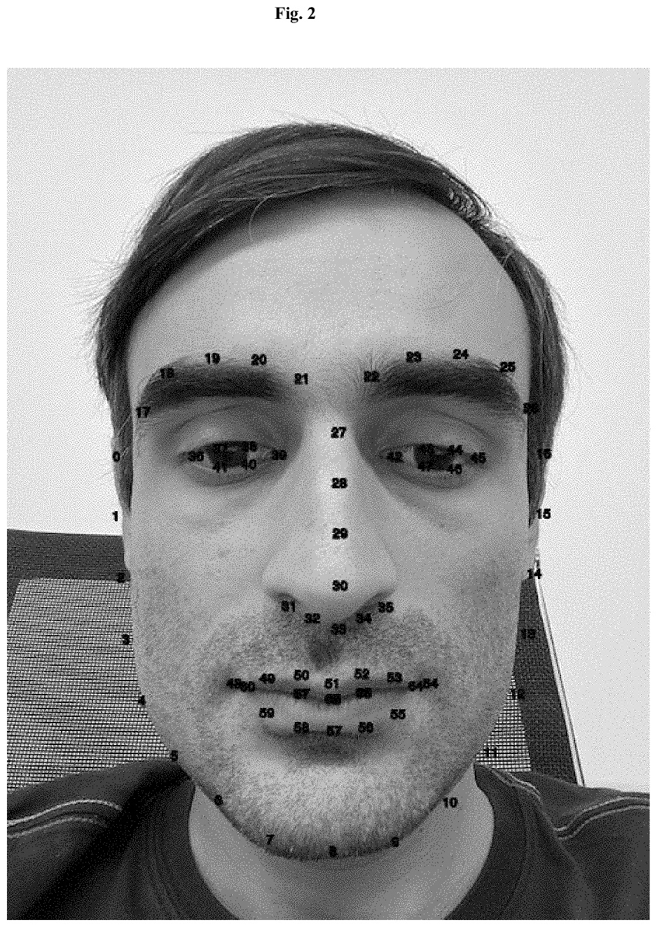

When conforming set of images has been acquired at 102, the system 100 then detects faces in the images and identifies some landmarks (face contour, eyes, nose, mouth, etc.) at the detector 103. The detector 103 uses up to 68 landmark models to detect a face in each of the three images. An exemplary image showing the landmarks is shown in FIG. 2. The numbers there indicating some of the landmarks detected from a center image. For example, landmark numbers 27, 28, 29 and 30 marks the bridge of the nose. Besides these landmark points, various other methods can be employed to determine fiducial points of a face such as a classifier or pattern recognition engine. In some embodiments, a Histogram of Oriented Gradients (HOG) is used to discern the face and the landmarks. Other methods that can be combined are an image pyramid or a sliding window to do detection.

After detecting the facial landmarks at detector 103, the stitching of the images takes place at 104. The stitching 104 first processes the right and left images by using the landmarks to cut a section of the image of the right and cut a section of the image on the left and combine them side by side.

First, the right image is cut by some preset amount using a common reference point from one of the landmarks (i.e. point 27 on bridge of the nose). The cutout section incorporates any offsets in the x and y directions. In some embodiments, the following formula/steps can be implemented in cutting a section of the right image:
Use the following rect function:
a. Width: Use point number 27's X—delta (which equals 10) (i.e. fiducial point 16)
b. Height: Use original image's height
c. X: 0
d. Y: 0

Then, the left image is cut at the equivalent preset amount using the same reference point from one of the landmarks as used to cut the right image. The cutout section incorporates any offsets in the x and y directions especially relative to the right image and its cutout. In some embodiments, the following formula/steps can be implemented in cutting a section of the left image:
Use the following rect function:
a. Width: Original image's width−point number 27's X
b. Height: Use original image's height
c. X: Point number 27's X
d. Y: 0

Finally, the two cutout images are set next to one another, accounting for any offsets in the x and y directions. In some embodiments, the following formula/steps can be implemented in cutting a section of the left image:
a. X: Image A width
   b. Y: −(Y of point number 27 of Image B−Y of point number 27 of Image A)

Furthermore, the stitching 104 creates a polygon that serves as a mask in copying over a section of the center image and creating another image. First, the polygon is filled with a black color and with a blur effect of 10 radius and 10 sigma, by using the following points (where K is another delta with value equal to 10). In some embodiments, the following formula/steps can be implemented in extracting a section from the center image:
a. 2·x+K,2·y
b. 2·x+(31·x−2·x)/2,31·y
c. 4·x+(48·x−4·x)/2,48·y
d. 4·x+(59·x−4·x)/2,59·y
e. 6·x+K,6·y
f. 7·x,7·y−K
g. 8·x,8·y−K
h. 9·x,9·y−K
i. 10·x−K,10·y
j. 55·x+(12·x−55·x)/2,55·y
k. 54·x+(12·x−54·x)/2,54·y
l. 35·x+(14·x−35·x)/2,35·y
m. 14·x−K,14·y
n. 28·x,28·y

This new image (cutout section of the center image) is then placed on top of the combined image cutouts of the right and left side by making sure they are anchored at specific reference points in the cutout left and right images. In some embodiments, the following formula/steps can be implemented in merging a section from the center image unto the combined left and right image:
a. X: (Image A width+Image B width)−Original width
b. Y: −(Y of point number 27 of Image C−Y of point number 27 of Image A)

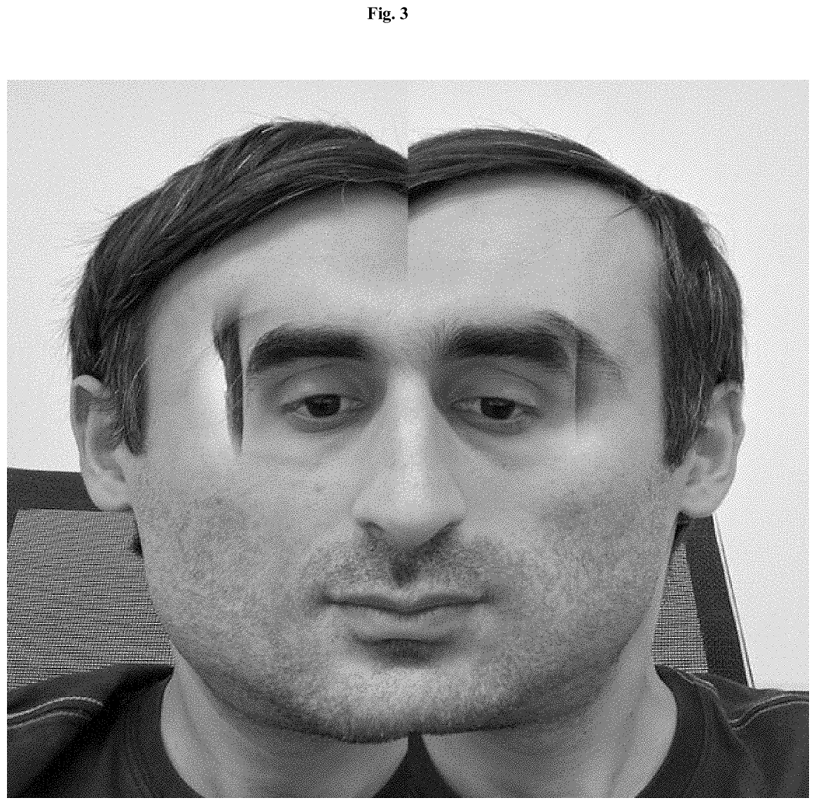

Then, the resulting image—as shown in FIG. 3—which contains the placed new image un top of the cutout right and left images is saved and outputted at 106.

At output stage 106, the user can then select the region, as recommended by the system 100, to be finalized into a custom facemask. Furthermore, the user has the ability of removing blemishes or further processing the image to apply filters and other transformations to their liking. The finalized format of the image then can be sent to a printer to order the customized mask that wraps around the face of the user. In some embodiments the finalized image is a wide angle or wrapping partial cutout of one's face, from nose to chin and both cheeks. This rendition of a partial face allows for a lifelike representation of the wearer's face, even though the mask is covering the actual anatomical parts of the face.

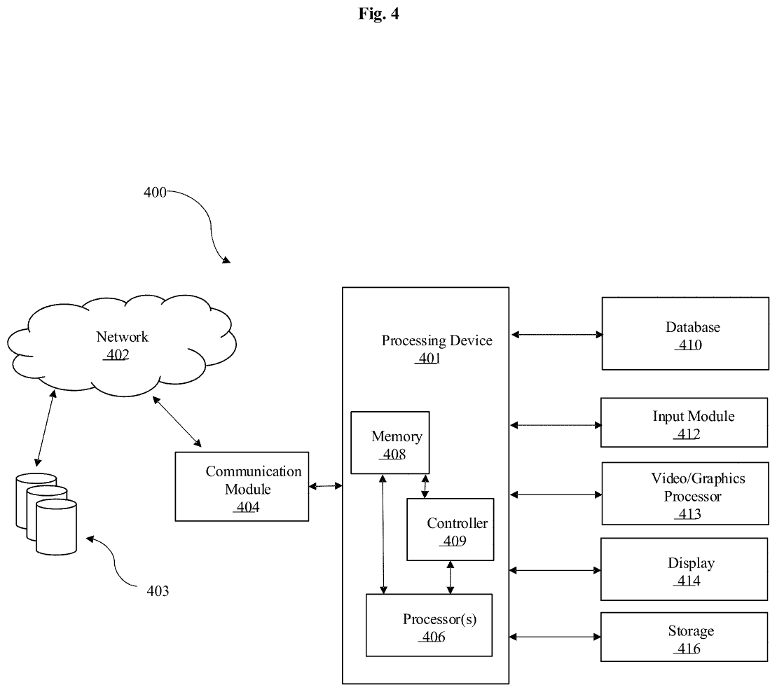

FIG. 4 is a block diagram of the platform of the system 100 showing the electronic and computational modules 400 that control the operation of the processes of system 100 and the method steps, discussed below.

The processing device 401 is a machine such as a computer, a tablet pc, a smart-phone, a smart-watch, an integrated AR/VR (Augmented Reality/Virtual Reality) headwear with the necessary computing and computer vision components installed, a smart-television, an interactive screen, a smart projector or a projected platform, an IoT (Internet of things) device or the like. The processing device 401 carries on all the operations and computational aspects of the system 100 using a processor 406, a memory 408 and a controller 409. The processor can be a Central Processing Unit (CPU), Graphics Processing Unit (GPU), Virtual Processing Unit (VPU), or a series of processors and/or microprocessors, but are not limited in this regard, connected in series or parallel to execute the functions relayed through the memory 408 which may house the software programs and/or sets of instructions.

The processor 406 and memory 408 are interconnected via bus lines or other intermediary connections. The processor 406 and controller 409 are also interconnected via bus lines or other intermediary connections. The controller 409 sends control signals to the other components of the system's 100 electronic and computational modules 400. The memory can be a conventional memory 408 device such as RAM (Random Access Memory), ROM (Read Only Memory) or other volatile or non-volatile basis that is connected to the processor(s) 406 and to the controller 409. The memory 408 includes one or more memory devices, each of which includes, or a plurality of which collectively include a computer readable storage medium. The computer readable storage medium may include a read-only memory (ROM), a flash memory, a floppy disk, a hard disk, an optical disc, a flash disk, a flash drive, a tape, a database accessible from a network, and/or any storage medium with the same functionality that can be contemplated by persons of ordinary skill in the art to which this disclosure pertains.

The processing device 401 is connected to various other aspects of the system's 100/300 electronic and computational modules 400. For example, the processing device 401 is connected to a communication module 404 which enables it to communicate with remote devices or servers on a wired or on a wireless basis. The communication module 404 in return can communicate with a network 402 such as a cloud or a web, on a need to basis. Thereby, receiving operational instructions and/or image information/data and/or processing data from a source other than what is available to the processor(s) 406 and/or the memory 408.

The processing device 401 is also connected to a database 410. The processing device 401 stores and can retrieve information from the database 410. The database entries may contain user information, saved settings, templates, filters and other data. The database 410 or its entries can be sent through the communication module 404 to the network 402.

The processing device 401 is also connected to the input module 412 in order to intake the user's directives and/or data such as images, mouse clicks, touchpad interaction, incorporation of a stylus pen, hand gestures, body “language”, eye gaze information, and/or voice commands. The input module 412 can be used to take and select the facial images based on a template or not. The input module 412 can also be used to select operational mode of the system 100 platform, send and receive data, video streams, select to apply filters, manipulate finalized images, order images, upload or download images, etc.

The processing device 401 is also connected to a video/graphics processor 413 that may be used, by the various components mentioned above, specifically the acquisition module 102, the detection module 103, the stitching module 104 and the output module 106 to process visual information.

The processing device 401 is also connected to a display 414 which is used to show the system's interface 100 and the resulting images. The display 414 is operated with the use of the video/graphics processor 413.

The processing device 401 is also connected to a storage 416 which may temporarily or permanently house other executable code, algorithms and programs such as the operating system or the system's 100 platform.

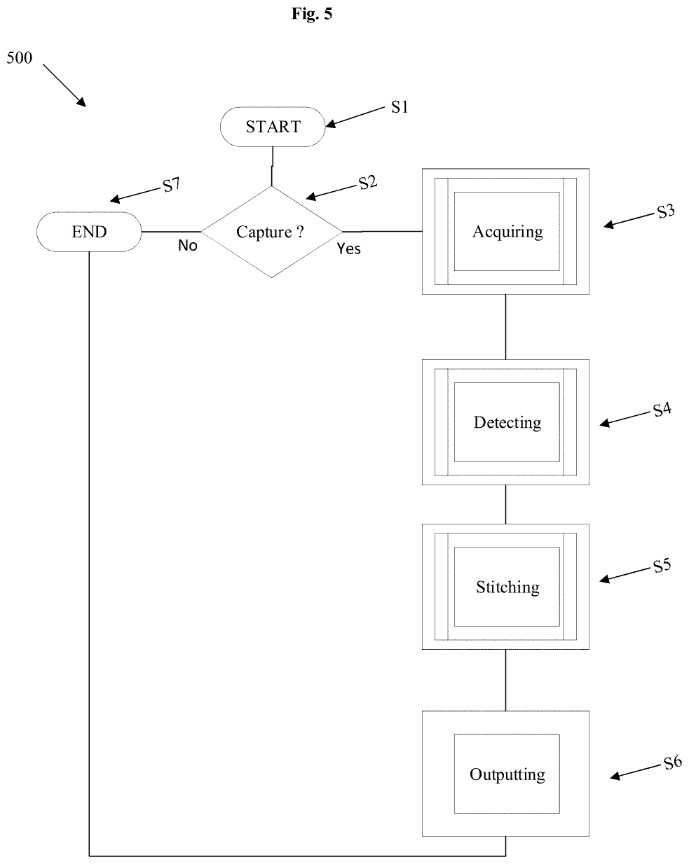

FIG. 5 depicts an exemplary flowchart illustrating the system's 100 method steps in environment 500. This method 500 is described for the system 100 as discussed above under FIGS. 1 and 4 which may be composed of various steps. Furthermore, other embodiments may be built upon this architecture and discussed herein. In step S1, the platform of the system 100 starts which is an indication that it is running on the user's machine. This can entail the user logging in with their credentials.

In step S2, a decision is made whether to capture an image(s) or not. If the decision is in the affirmative, then it proceeds to step S3 to acquire the images(s). If the decision is negative, then the process ends at step S7. At step S3, the process allows the user to take three shots of their face. The set of images capture the left, the right and center perspective of the face. The user can be guided through taking these images with use of a templates shown on a display when they are holding the data acquisition component (camera or visual sensor) towards their face. In other embodiments, this can be done in front of a mirror. In other embodiments the acquisition process can involve using an already saved images from the user's machine and or a remote location that houses the images. Those images can in turn be selected and the template can be placed on them to select a left, right and center image of the face.

At step S4, the system 100 starts detecting faces and the landmarks in the right, left and center. In some embodiments, the system 100 can carry out the detection part of the process on a remote server. The set of images has some landmarks (face contour, eyes, nose, mouth, etc.) sometimes up to 68 landmark models to detect a face in each of the three images. Besides these landmark points, various other methods can be employed to determine fiducial points of a face such as a classifier or pattern recognition engine. In some embodiments, a Histogram of Oriented Gradients (HOG) is used to discern the face and the landmarks

At step S5, the system 100 starts stitching of the images. The stitching first processes the right and left images by using the landmarks to cut a section of the image of the right and cut a section of the image on the left and combine them side by side. First, the right image is cut by some preset amount using a common reference point from one of the landmarks. The cutout section incorporates any offsets in the x and y directions. Then, the left image is cut at the equivalent present amount using the same reference point from one of the landmarks. The cutout section incorporates any offsets in the x and y directions especially relative to the right image and its cutout. Finally, the two cutout images are set next to one another accounting for any offsets in the x and y directions.

Furthermore, the stitching creates a polygon that serves as a mask in copying over a section of the center image unto the polygon which results into another image. This new image (cutout section of the center image) is then placed on top of the combined image cutouts of the right and left side by making sure they are anchored at specific reference points in the cutout left and right images. Then, the resulting image which contains the placed new image un top of the cutout right and left images is saved and outputted at step S6.

At step S6, the system 100 outputs the saved image which the user can then select as candidate region, as recommended by the system 100, to be finalized into a custom facemask. Furthermore, the user has the ability of removing blemishes or further processing the image to apply filters and other transformations to their liking.

At step S7, the process ends and the user can send the finalized format of the image to a printer to order the customized mask that wraps around the face of the user.

As stated above, these method steps can be carried out by the system and its components as discussed under 400. Furthermore, the method 500 and the process steps are not limited in certain sequences and therefore the steps illustrated hereon can be carried out in synchronous to one another, asynchronous to one another, running in serial steps or in parallel steps on a single machine or in a distributed format.

It should be noted that, in some embodiments, the method 500 may be implemented as a computer program. When the computer program is executed by a computer, an electronic device, or the one or more processors 406 in FIG. 4, carries on the method 500. The computer program can be stored in a non-transitory computer readable medium such as a ROM, a flash memory, a floppy disk, a hard disk, an optical disc, a flash disk, a flash drive, a tape, a database accessible from a network, or any storage medium with the same functionality that can be contemplated by persons of ordinary skill in the art to which this disclosure pertains.

In addition, it should be noted that in the operations of the following method 500, no particular sequence is required unless otherwise specified. Moreover, the following operations may also be performed simultaneously, or the execution times thereof may at least partially overlap.

Furthermore, the operations of the following method 500 may be added to, replaced, and/or eliminated as appropriate, in accordance with various embodiments of the present disclosure.

Although the present disclosure has been described in considerable detail with reference to certain embodiments thereof, other embodiments are possible. Therefore, the scope of the appended claims should not be limited to the description of the embodiments contained herein.

We claim:

1. A method of stitching multiple images for creating a facemask, comprising:
capturing a right-side image of a face;
capturing a left-side image of the face;
capturing a center-side image of the face;
detecting facial landmarks from each of the captured images;
processing each of the captured images;
stitching the processed images together; and
outputting the resulting stitched image.

2. The method of stitching multiple images for creating a facemask of claim 1, wherein the detecting of facial landmarks uses a Histogram of Oriented Gradients (HOG) to find the landmark points.

3. The method of stitching multiple images for creating a facemask of claim 2, wherein the processing of the captured images further includes:
processing the right-side image by cropping a section of the face, based on some of the facial landmarks;
processing the left-side image by cropping a section of the face, based on some of the facial landmarks; and
processing the center-side image by setting a polygon section of the face, based on some of the facial landmarks, and using the polygon section as a mask to extract pixels from the center-side image that results into the processed center-side image.

4. The method of stitching multiple images for creating a facemask of claim 3, wherein, the stitching of the images together includes:
setting the processed left-side image next to the processed right-side image such that a common landmark reference point is used to align the y-coordinate and the width of the processed right-side image is used to align the x-coordinate; and
overlaying the processed center-side image on top of the stitched processed left-side image that was placed next to the processed right-side image such that the overlaying of the processed center-side image is anchored at an x-coordinate based on the addition of the widths of the processed left-side image and the processed right-side image subtracted by the original width and further anchored at a y-coordinate based on a common landmark reference point of the processed right-side image and the center-side image.

5. The method of stitching multiple images for creating a facemask of claim 4, wherein the resulting stitched image is outputted for the user to generate a facemask based on a template of a facemask.

6. A system of stitching multiple images for creating a facemask, comprising:
one or more processors operatively coupled to one or more memory devices;
one or more set of instructions, wherein the one or more set of instructions are stored in the one or more memory devices and configured to be executed by the one or more processors, wherein the one or more set of instructions include executable instructions to:
capture a right-side image of a face;
capture a left-side image of the face;
capture a center-side image of the face;
detect facial landmarks from each of the captured images;
process each of the captured images;
stitch the processed images together; and
output the resulting stitched image.

7. The system of stitching multiple images for creating a facemask of claim 6, wherein the one or more set of instructions further includes executable instructions to detect facial landmarks using a Histogram of Oriented Gradients (HOG) to find the landmark points.

8. The system of stitching multiple images for creating a facemask of claim 7, wherein the one or more set of instructions further includes executable instructions to:
process the right-side image by cropping a section of the face, based on some of the facial landmarks;
process the left-side image by cropping a section of the face, based on some of the facial landmarks; and
process the center-side image by setting a polygon section of the face, based on some of the facial landmarks, and using the polygon section as a mask to extract pixels from the center-side image that results into the processed center-side image.

9. The system of stitching multiple images for creating a facemask of claim 8, wherein the one or more set of instructions further includes executable instructions to:
set the processed left-side image next to the processed right-side image such that a common landmark reference point is used to align the y-coordinate and the width of the processed right-side image is used to align the x-coordinate; and
overlay the processed center-side image on top of the stitched processed left-side image that was placed next to the processed right-side image such that the overlaying of the processed center-side image is anchored at an x-coordinate based on the addition of the widths of the processed left-side image and the processed right-side image subtracted by the original width and further anchored at a y-coordinate based on a common landmark reference point of the processed right-side image and the center-side image.

10. The system of stitching multiple images for creating a facemask of claim 9, wherein the one or more set of instructions further includes executable instructions to output a resulting stitched image for the user to generate a facemask based on a template of a facemask.

11. A computer program product of stitching multiple images for creating a facemask, the computer program product comprising a non-transitory computer readable storage medium having program instructions embodied therewith, the program instructions executable by a computing device to cause the computing device to perform the method comprising:
capturing a right-side image of a face;
capturing a left-side image of the face;
capturing a center-side image of the face;
detecting facial landmarks from each of the captured images;
processing each of the captured images;
stitching the processed images together; and
outputting the resulting stitched image.

12. The computer program product of claim 11, wherein the program instructions are further executable by a computing device to cause the computing device to perform the method of detecting facial landmarks using a Histogram of Oriented Gradients (HOG) to find the landmark points.

13. The computer program product of claim 12, wherein the program instructions are further executable by a computing device to cause the computing device to perform the method comprising:
processing the right-side image by cropping a section of the face, based on some of the facial landmarks;
processing the left-side image by cropping a section of the face, based on some of the facial landmarks; and
processing the center-side image by setting a polygon section of the face, based on some of the facial landmarks, and using the polygon section as a mask to extract pixels from the center-side image that results into the processed center-side image.

14. The computer program product of claim 13, wherein the program instructions are further executable by a computing device to cause the computing device to perform the method comprising:
setting the processed left-side image next to the processed right-side image such that a common landmark reference point is used to align the y-coordinate and the width of the processed right-side image is used to align the x-coordinate; and
overlaying the processed center-side image on top of the stitched processed left-side image that was placed next to the processed right-side image such that the overlaying of the processed center-side image is anchored at an x-coordinate based on the addition of the widths of the processed left-side image and the processed right-side image subtracted by the original width and further anchored at a y-coordinate based on a common landmark reference point of the processed right-side image and the center-side image.

15. The computer program product of claim 14, wherein the program instructions are further executable by a computing device to cause the computing device to perform the method of outputting the resulting stitched image for the user to generate a facemask based on a template of a facemask.
